(19) United States
(12) Patent Application Publication
(10) Pub. No.: US 2005/0177504 A1
(43) Pub. Date: Aug. 11, 2005

(54) System and method for remotely authorizing a payment transaction file over an open network

(75) Inventor: Steven A. Crosson Smith, Winnersh Berkshire (GB)

Correspondence Address: TIMOTHY P. O'HAGAN, 8710 KILKENNY CT, FORT MYERS, FL, 33912, US

(73) Assignee: Bottomline Technologies (DE) Inc., Portsmouth, NH (US)

(21) Appl. No.: 10/830,830

(22) Filed: Apr. 23, 2004

Related U.S. Application Data
(63) Continuation-in-part of application No. 10/776,407, filed on Feb. 10, 2004.

(51) Int. Cl. G06F 17/60

(52) U.S. Cl. 705/40; 705/64

(57) ABSTRACT

A system is provided for approving an electronic fund transfer disbursement file and instructing a remote payment management system to generate and electronic fund transfer system to a payment processing server. The system comprises a network services module, a digital signature system and an electronic fund transfer submission module. The network services module establishes a secure connection to the remote payment management system. The digital signature system: i) returns a digital signature of a data file in response to a signature only processing call; and ii) returns a digital signature data structure in response to receiving a sign and package processing call. The electronic fund transfer submission module obtains an authorization request from the remote payment management system. The authorization request comprises a digest of the electronic fund transfer disbursement file. A dummy data file is passed to the digital signature system and a dummy data structure is returned. The dummy data structure comprises a dummy digest, a dummy digital signature of the dummy digest, and a digital certificate. The digest is also passed to the digital signature system and a digital signature of the digest is returned. An authentication data structure is build by replacing the dummy digest with the digest and replacing the dummy digital signature with the digital signature of the digest and is returned to the payment management system.

### CROSS-REFERENCE TO RELATED ACTIONS

This application claims the benefit of, and is a continuation in part of U.S. patent application Ser. No. 10/776,407 filed on Feb. 10, 2004 entitled “Method for Remotely Authorizing a Payment Transaction File over an Open Network”, the contents of such patent application being incorporated herein.

### TECHNICAL FIELD

The present invention relates generally to a computerized payment management system and method, and more specifically, to a computerized payment management system and method for enabling a user of a remote system to authorize a payment transaction file over an open network.

### BACKGROUND OF THE INVENTION

A typical business utilizes an accounting software system (or an accounting module to its enterprise resource planning system or other database systems) that maintains a database of the business' transactions with its customer, vendors, employees, banks, and other third parties associated with the business. Such accounting systems are typically architected as a transaction database wherein data is input into the system through predefined transactions and extracted from the system utilizing database reporting modules.

In the early accounting systems, payments to third party payees were effectuated entirely outside of the accounting software system. An appropriately authorized operator would utilize a reporting module to obtain a listing of payments to be made to various payees. The operator would then issue a payment draft or check to each payee either by manually filling in payment information in a pre-printed draft form or by entering the payment into a secure check printing software system which, in turn, prints each draft on either a pre-printed form or on blank check stock. After the drafts are printed, the operator will enter one or more payment transactions into the accounting system to indicate that the payments have been issued.

With advanced payment management solutions, the accounting system may output a payments file which includes a plurality of records, each reflecting a payment to be issued. An appropriately authorized operator would import the payments file to the payments management solution. A check printing module of the payments management solution prints a draft corresponding to each record within the payments file on either a pre-printed form or on blank check stock. After the drafts are printed, the operator will typically enter only a single acknowledgement transaction into the accounting system to indicate that all payments within the payments file have been issued.

More advanced solutions may support electronic fund transfer payments. More specifically, the payments management solution may receive a payments file from the accounting system and generate a plurality of electronic fund transfer transactions for execution by an applicable financial institution.

When an electronic fund transfer transaction file is transferred to a financial institution, there is a well recognized need for the financial institution to be assured that the transaction file is accurate and appropriately authorized. One known solution utilized for assuring that a transaction file is accurate and appropriately authorized is a system utilized by the Bankers Automated Clearing System (BACS) and referred to as BACSTEL IP. In the BACSTEL IP system, a member financial institution (or some other trusted certificate authority) issues a digital certificate—which binds a public key of an asymmetric key pair to a user who is known to have the authority to authorize electronic fund transaction payments (e.g. an authorized user). The digital certificate and the private key of the key pair is securely stored on a smart card or other hardware key that is issued to the authorized user.

The authorized user runs a BACSTEL IP digital signature software component on his or her computer along with a program for interfacing with the financial institutions BACSTEL IP systems and an interface to a smart card reader.

The digital signature software component receives a data file from a higher level system and performs the following processes. First, the component performs a first SHA-1 hash of the data file to generate a 160-bit string commonly known as a digest. An SHA-1 hash is a well known secure hash algorithm developed by the National Institute of Standards and Technology which is useful for generating a 160-bit hash of any data file with a size up to 264 bits in length. The component then combines the digest with other message attributes such as the current date and attribute type. The combination is referred to as the authenticated attributes. The authenticated attributes are then SHA-1 hashed to generate a second 160-bit hash string. The second 160-bit string is passed to the user's smart card. The smart card returns a digital signature of the 160-bit string along with the user's digital certificate and certificate chain. The component then generates a data structure known as a PKCS#7 which includes the digest, the digital signature, and the authorized user's digital certificate and certificate chain. The PKCS#7 and the electronic fund transfer transaction file are then passed to the BACSTEL IP systems.

The smart card, in conjunction with its PC resident driver code, comprises executable code which receives data for digital signature, prompts the authorized user to input a secret PIN number for authentication, and, in response to receiving the correct PIN number, returns a digital signature of the file along with the user's certificate and certificate chain.

When an authorized user is ready to submit an electronic fund transfer file to the BACSTEL system, the following process is used to assure that the transaction file is accurate and appropriately authorized.

First, the user's system presents the electronic fund transfer transaction file to the digital signature software component. As discussed above, the component will return a PKCS#7 data structure which includes a digest of the transaction file, a digital signature of the authenticated attributes, and the user's digital certificate and certificate chain.

The user's system then establishes a secure socket layer (SSL) connection to the financial institution's BACSTEL system. After the SSL connection is established, the BACSTEL system provides an authentication challenge to the user's system. The authentication challenge includes a randomly generated message.

Upon receipt of the authentication challenge, the user's system presents the random message to the digital signature software component which returns a digital signature and the user' digital certificate and certificate chain. These are passed back to the BACSTEL system.

After receiving an indication that the BACSTEL system has authenticated the user (the digital signature is that of the authorized user identified in the digital certificate), the user's system presents the PKCS#7 data structure and the transaction file to the BACSTEL system.

The financial institution can verify the integrity of the transaction file by verifying the signature (e.g. calculating a hash of the authenticated attributes for comparison to the result of decrypting the digital signature). If the digital signature is valid, the bank is assured that the transaction file presented to the BACSTEL system is the same transaction file presented to the digital signature software component.

There exists a desire in the industry to manage payments utilizing a payments solution, with a database located on a centralized server that is accessible by remote client devices over open networks such as the Internet. This client server architecture retains all data on the centralized server resulting in the payment data being more secure and more easily audited.

The problem with the above described digital signature solution is that it requires that the entire transaction file be located on the user's system so that it can be presented to the digital signature software component. This creates at least one problem.

If the transaction file is originally generated on a centralized server, the entire transaction file must be transferred to the remote client for digital signature. If the file is large, transferring the file can require significant network bandwidth and/or significant down load time if the user's connection is at a low data rate—such as dial-up. Further, transferring the transaction file to the remote client opens additional opportunities for a security breach as the transaction file may be inadvertently (or intentionally) stored in an insecure location on the remote client. Further yet, transferring the transaction file to the remote client creates audit issues as it would be possible to alter the transaction file on the user's system prior to digital signature and presentation to the BACSTEL system.

What is needed is a payments management system that includes a server and client architecture and enables a remote approver to authorize a payments file in a manner that does not suffer the disadvantages of transferring a transaction file to a user's remote system.

### SUMMARY OF THE INVENTION

A first aspect of the present invention is to provide a system for approving an electronic fund transfer disbursement file and instructing a remote payment management system to generate and electronic fund transfer system to a payment processing server. The payment processing server may be controlled by a financial institution and accept electronic fund transfer disbursement files in accordance with the BACSTEL system.

The systems comprises a network services module for establishing a secure connection to the remote payment management system. The system also comprises a digital signature system for: i) returning a digital signature of a data file in response to a signature only processing call; and ii) returning a digital signature data structure in response to receiving a sign and package processing call.

An EFT submission module is coupled to the network services module and the digital signature system and provides for obtaining an authorization request corresponding to the electronic fund transfer disbursement file from the remote payment management system. The authorization request comprising a digest of the electronic fund transfer disbursement file. The EFT submission module further provides for: i) passing a dummy data file to the digital signature system as part of a sign and package processing call; ii) obtaining a dummy data structure from the digital signature system, the dummy data structure comprising a dummy digest, a dummy digital signature of the dummy digest, and a digital certificate; iii) passing the digest to the digital signature system as part of a sign only processing call; iv) obtaining a digital signature of the digest from the digital signature system; v) building an authentication data structure from the dummy data structure by replacing the dummy digest with the digest and replacing the dummy digital signature with the digital signature of the digest; and vi) returning the authentication data structure to the payment management system.

The EFT submission module may further provide for returning the authentication data structure to the payment management system as part of an authorization response. The authorization response comprises the authentication data structure and verification components. The verification components include the digest.

The authorization request may further include summary attributes. The summary attributes comprising at least one attribute selected from the group of attributes consisting of: i) the total number of disbursements in the electronic fund transfer disbursement file; ii) the highest valued disbursement in the electronic fund transfer disbursement file; and iii) the sum of all disbursements in the electronic fund transfer disbursement file. In which case, the verification components may further include the summary attributes to assure that there has not been any change in the “round-trip” from the payment management system, to the EFT submission module, and return.

As part of the submission process, the EFT submission module may further provide for obtaining, from remote payment management system: i) credentials of a secure connection between the remote payment management system and the payment processing server; and ii) an authentication challenge. The authentication challenge may include a data string generated by the payment processing server. The EFT submission module: i) displays the credentials of the secure connection between the remote payment management system and the payment processor; ii) passes the data string to the digital signature system as part of a sign and package processing call; iii) obtains a challenge response from the digital signature system; and iv) returns the challenge response to the remote payment management system.

For a better understanding of the present invention, together with other and further aspects thereof, reference is made to the following description, taken in conjunction with the accompanying drawings. The scope of the invention is set forth in the appended claims.

### BRIEF DESCRIPTION OF THE DRAWINGS

FIG. 1 is a block diagram useful for discussing an automated payment system in accordance with one embodiment of the present invention;

FIG. 2a is a table representing an authorization request in accordance with an exemplary embodiment of the present invention;

FIG. 2b is a table representing a dummy data structure in accordance with an exemplary embodiment of the present invention;

FIG. 2c is a table representing an authorization data structure in accordance with an exemplary embodiment of the present invention;

FIG. 2d is a table representing an authorization response in accordance with an exemplary embodiment of the present invention;

FIG. 3 is a ladder diagram representing an authorization processes in accordance with one embodiment of the present invention;

FIG. 4 is an exemplary user authentication and access level table;

FIG. 5 is a table representing an exemplary payment database.

FIG. 6a is a flow chart representing exemplary operation of a log on module of a payment management system in accordance with one embodiment of the present invention;

FIG. 6b is a flow chart representing exemplary operation of a batch selection module of a payment management system in accordance with one embodiment of the present invention;

FIG. 6c is a flow chart representing exemplary operation of an EFT submission module of a payment management system in accordance with one embodiment of the present invention;

FIG. 7a is a flow chart representing exemplary operation of a log on module of a client payment management application in accordance with one embodiment of the present invention; and

FIG. 7b is a flow chart representing exemplary operation of an EFT submission module of a client payment management application in accordance with one embodiment of the present invention.

### DETAILED DESCRIPTION OF THE INVENTION

The present invention is now described in detail with reference to the drawings. In the drawings, each element with a reference number is similar to other elements with the same reference number independent of any letter designation following the reference number. In the text, a reference number with a specific letter designation following the reference number refers to the specific element with the number and letter designation and a reference number without a specific letter designation refers to all elements with the same reference number independent of any letter designation following the reference number in the drawings.

It should also be appreciated that many of the elements discussed in this specification may be implemented in hardware circuit(s), a processor executing software code, or a combination of a hardware circuit and a processor executing code. As such, the term circuit, module, or engine as used throughout this specification is intended to encompass a hardware circuit (whether discrete elements or an integrated circuit block), a processor executing code, or a combination of a hardware circuit and a processor executing code, or other combinations of the above known to those skilled in the art.

It should also be appreciated that for purposes of illustrating the exemplary embodiments of the invention, certain functions that may be performed by a processor executing software code have been grouped into elements referred to as circuits, modules, or engines. Such grouping of functions is for clarity of the discussion only and those skilled in the art of software design understand that grouping of functions within modular software design is a matter of design choice.

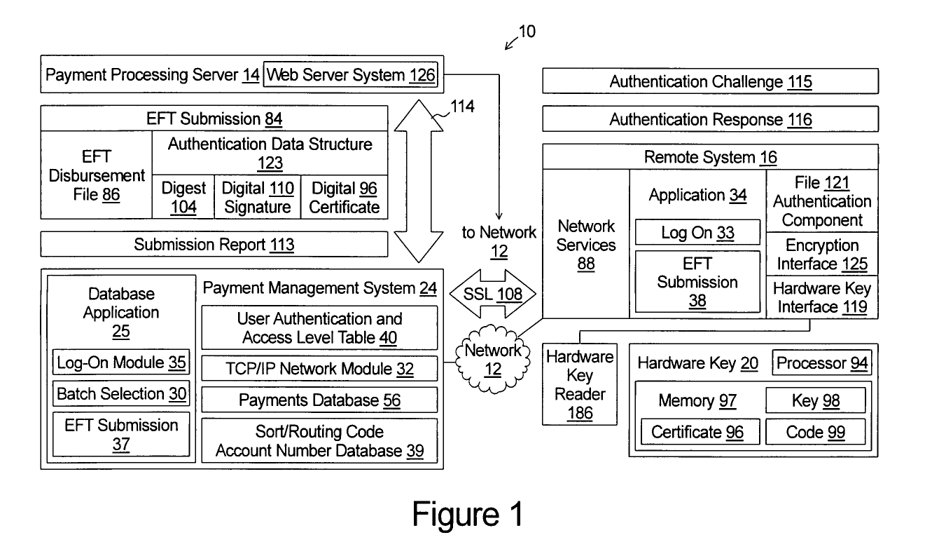

FIG. 1 illustrates exemplary architecture of an automated payment system 10 in accordance with one embodiment of the present invention. The architecture of the payment system 10 comprises a payment processing server 14, a payment management system 24, and at least one remote system 16, each of which communicates utilizing secure socket connections and TCP/IP protocols over various open network systems commonly known as the Internet 12. Those skilled in the art will recognize that as an alternative architecture, the various components may communicate with each other via dial up PSTN connections or ISDN connections. However, for purposes of illustrating an exemplary embodiment of the present invention, the architecture utilizing the Internet 12 will be described.

The payment processing server 14 may comprise a combination of secure servers controlled by a financial institution for receiving an electronic fund transfer (EFT) submission 84 in a predetermined format. In an exemplary embodiment, the payment processing server 14 may comprise a system for receiving an EFT submission 84 comprising an EFT disbursement file 86 which includes a plurality of records. Each record represents an electronic fund transfer payment. Exemplary EFT payments include BACS payments, however, SWIFT payments, and ACH payments are also envisioned.

The payment management system 24 may be embodied in software operated by one or more computer server systems. In operation, the payment management system 24 is useful for effecting electronic fund transfer (EFT) disbursements to third parties in accordance with payment instructions provided by an authorized user of a client system 16.

Because electronic fund transfers can be an attractive means by which fraudulent individuals may practice their art and because the payment processing server 14, which is a portal for entry of EFT submissions, is coupled to the Internet 12, the payment management system 24 must operate systems for assuring that each EFT submission 84 that is provided to the payment processing server 14 is duly authorized by an account holder. More specifically, an EFT submission 84 not only includes the EFT disbursement file 86, but also includes an authentication data structure 123. The authentication data structure 123 includes a digest 104 of the EFT disbursement file 86, a digital signature 110 of hashed authenticated attributes 109 and a digital certificate of a duly authorized user and a certificate chain up to, but not including the root certificate (collectively referred to as the digital certificate and certificate chain 96)—all of which are discussed in more detail herein. In the exemplary embodiment, the authentication data structure is embodied in a PKCS#7 message or other similar message.

The components of the payment management system 24 useful for implementation of the present invention include a database application 25 for: i) interfacing (via a TCP/IP network module 32) with the payment processing server 14; ii) interfacing (via a TCP/IP network module 32) with a payment management application 34 of each remote system 16; and iii) for controlling a payments database 56, a user authentication and access level table 40, and a sort/routing code and account number database 39—each of which is discussed in more detail herein.

Remote Systems

Each remote system 16 may be a typical personal computer system that includes a TCP/IP network module 88, a hardware key interface 119, f an encryption interface 125, a file authentication component 121, and a payment management application 34.

The TCP/IP network module 88 may be a known system for establishing a TCP/IP connection between application level systems and enabling communication there between over a TCP/IP compliant network.

The hardware key interface 119 interfaces between the encryption interface 125 and a hardware key 20 (via a hardware key reader 186).

In the exemplary embodiment, the hardware key 20 is embodied in a smart card that is uniquely assigned to the authorized user 50 and is coupled to the remote system 16 via a point-to-point hardware key interface 186 such as serial UART, USB, PCMCIA or similar interfaces. The hardware key 20 includes a processor 94 and nonvolatile memory 97. The nonvolatile memory 97 includes a digital certificate and certificate chain 96, a private encryption key 98, and code 99 for signing data presented for digital signature.

The digital certificate and certificate chain 96 includes: i) a public encryption key which corresponds to the private encryption key 98, ii) the identity of the authorized user 50 to which the hardware key 20 was issued, and iii) a trusted certificate authority's digital signature of both the public key and the identity of the authorized user 50.

The hardware key interface 119 provides for the hardware key 20 to perform a digital signature process only if the user enters a correct personal identification number (PIN). As such, upon receipt of data for signature from the encryption interface 125, the hardware key interface 119 provides for the remote system 16 to display a dialog box soliciting user input of his or her PIN. Upon receipt of the correct PIN, the hardware key interface 119 passes the data to the hardware key 20 for digital signature. Assuming that the PIN is correct, the hardware key 20 will encrypt the data presented with the private encryption key 98 thereby generating a digital signature and return the digital signature with the user's digital certificate and certificate chain 96.

The encryption interface 125 may be an operating system component such as the Cryptographic API (CAPI) that is part of Microsoft's Windows operating system. The encryption interface 125 interfaces between the file authentication component 121 and the hardware key interface 119. The purpose of the encryption interfaced 125 is to enable the file authentication component 121 to obtain a digital signature of data using standardized processing calls independent of the particular vendor of the particular technology of the hardware key interface 119, the hardware key reader 186, and the hardware key 20.

The file authentication component 121 may be a digital signature software component as discussed in the background. In response to receiving data as part of a processing call to digitally sign and package the data, the file authentication component 121: i) passes the data to the encryption interface 125 as part of a hash processing call; ii) obtains 160-bit string called a digest (e.g. and SHA-1 hash of the data) from the encryption interface 125; iii) combines the digest with other authenticated attributes; iv) passes the combination of the digest and the other authenticated attributes to the encryption interface 125 as part of a hash and sign processing call; v) receives the digital signature and digital certificate and certificate chain from the encryption interface 125; and vi) and builds an authentication data structure for return to the system that made the sign and package processing call to the authentication component 121. The authentication data structure is a data structure expected by the payment processing server and includes information for authenticating a payments file submitted therewith.

In addition, the file authentication component 121 may, in response to receiving data as part of a processing call to digitally sign the data only: i) pass the presented data to the encryption interface 125 for hashing and an applicable digital signature of the hash; ii) receive the digital signature from the encryption interface 125; and iii) present the digital signature to the system that made the sign only processing call to the authentication component 121.

The payment management application 34 comprises a log-on module 33 and an EFT transaction file submission module 38. Operation of each such module will be discussed in more detail herein. In combination, such modules interface with the payment management system 24 over a first secure socket layer network connection 108 to: i) select an EFT disbursement file 86 for submission to the payment processing server 14; and ii) remotely approve the EFT disbursement file 86 for submission to the payment processing server 14.

To select an EFT disbursement file 86 for submission, the payment management application 34 may receive, from the payment management system 24, a list of available batches and summary attributes thereof, generate a display of the batches and summary attributes in a grid format, and solicit user selection of a batch(es) for submission.

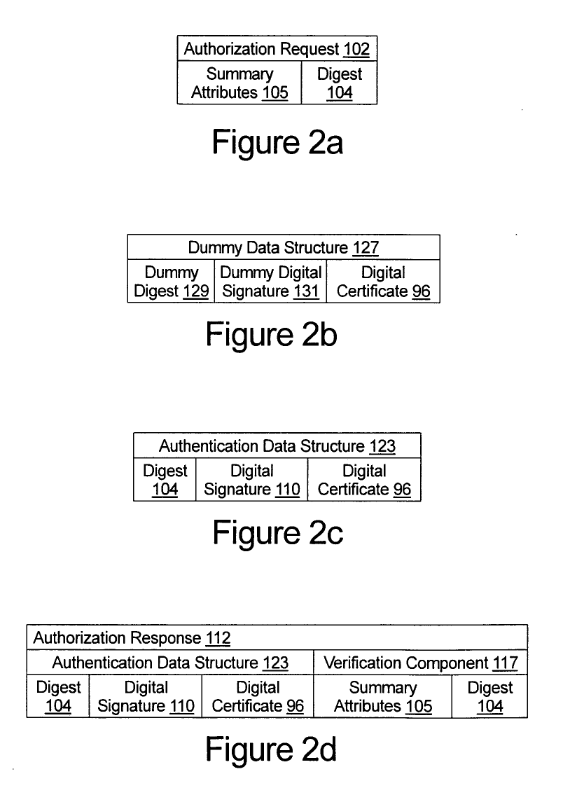

To approve an EFT disbursement file 86 for submission to the payment processing server 14, the payment management application 34 solicits an authorization request 102 (FIG. 2a) from the payment management system 24 and generates an authorization response 112 (FIG. 2d) in response thereto. A more detailed discussion of the payment management application 34 is included herein.

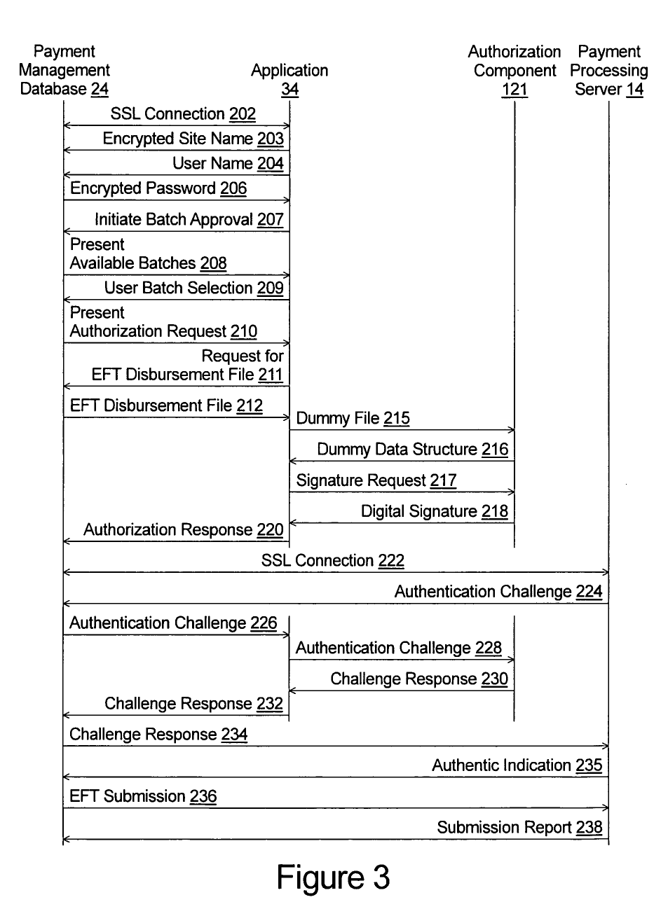

The ladder diagram of FIG. 3 represents exemplary operation of the systems for authorizing each EFT submission 84. Referring to FIG. 3, in conjunction with FIG. 1, step 202 represents establishment of a first secure socket layer (SSL) connection 108 between the payment management system 24 and the payments application 34 of the remote system 16. More specifically, the payment application 34 of the remote system 16 will interface with the network services module 88 to initiate aTCP/IP connection by initiating a known three-way TCP handshake with the TCP/IP network module 32 of the payment management system 24. Thereafter, TLS handshaking is performed to complete the first SSL connection 108.

Step 203 represents the payment management application 34 of the remote system 16 providing its pre-assigned site name (in encrypted form) to the payment management system 24. The pre-assigned site name is effectively a secret key password which provides some security in that a user may only interact with the payment management system 24 utilizing a work station that has been previously “registered” with the payment management system 24 and given a pre-assigned site name. Assuming the pre-assigned site name matches an authorized site, the payment management system 24 binds the session to the payment management application 34 operating on the remote system 16.

Step 204 represents receiving a user name from the payment management application 34 over the first secure connection 108. The payment management application 34 presents a user name and password challenge to the user of the system 16 which request that the user of the remote system 16 enter his or her user name and password.

Step 206 represents return of the user name and password to the payment management server 32 over the first SSL connection 108.

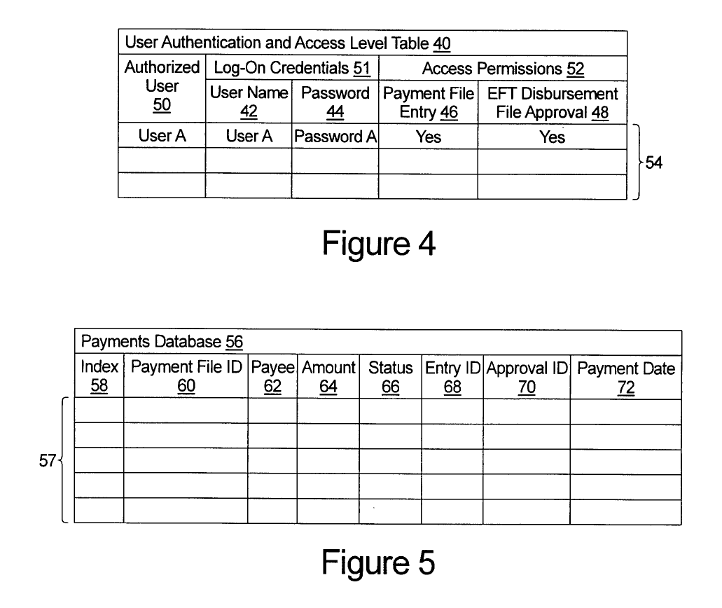

Upon receipt, the payment management system 24 will verify that the user name provided by the user of the remote system 16 represent an authorized user 50. More specifically, and with brief reference to FIG. 4 in conjunction with FIGS. 1 and 2, the payment management system 24 includes a user authentication and access level table 40. The user authentication and access level table 40 comprises a plurality of records 54. Each record 54 is associated with an authorized user 50. Associated with each authorized user 50 are: i) the user's logon credentials 51 (including his or her user name 42 and his or her encrypted password 44); and ii) the user's access permissions 52 which include an indication of certain functions that the user 50 is authorized to perform. For example, User A is authorized to perform payment file entry 46 and approval of EFT disbursement files 86.

Returning to FIG. 3 in conjunction with FIG. 1, assuming that the user name provided by the user matches an authorized user 50, the encrypted password 44 stored in association with the user name 42 in the user authentication and access level table 40 is returned to the payment management application 34 at step 206.

Upon receipt of the encrypted password 44 from the payment management system 24, the payment management application 34 compares the password tendered by the user (after encryption) to the encrypted password 44. If the two do not match, the user has tendered the wrong password and access is denied. If the two match, the payment management application 34 requests that the payment management system 24 present available batches and summary attributes at step 207.

Upon obtaining an instruction to present available batches, the payment management system 24 calculates or obtains summary attributes 105 (FIG. 2a) from a batch header(s) (of available batches) and presents the summary attributes 105 to the payment management application 34 for display in a grid format at step 208.

The summary attributes 105 may include such values as the total number of EFT disbursements within the EFT disbursement file 86, the sum of all disbursements within the EFT disbursement file 86, the highest value EFT disbursements within the EFT disbursement file 86, and other attributes useful by a human operator for understanding the significance of the payments included with in the file 86.

Step 209 represents the payment management application 34: i) displaying the summary attributes 105 to the authorized user 50 in grid format, ii) soliciting the authorized user 50 to select an EFT disbursement file 86 for approval by digital signature, and iii) upon user 50 election to approve the EFT disbursement file 86, soliciting an authorization request 102, as shown in FIG. 2a, from the payment management system 24.

Upon receipt of a selection of an EFT disbursement file 86 for approval, the payment management system 24 compares the summary attributes 105 provided by the remote system 16 (as part of the request) to locally generated summary attributes 105 to assure that there is a match, extracts the selected EFT disbursement field 86 form the payments database 56, performs and SHA-1 hash of the EFT disbursement file 86 to generate a digest 104, and encrypts the EFT disbursement file 86 for temporary storage.

The payment management system 24 then, at step 210, provides the authorization request 102 to the payment management application 34. The authorization request 102 includes the digest 104, and the summary attributes 105. In response to receiving the authorization request 102, the payment management application 34 may display the summary attributes 105 (the digest 104 is not displayed) and solicit: i) user selection to sign and return an authorization response 112 (e.g. selection of a sign button), and ii) user selection to view the entire EFT disbursement file 86 (e.g. selection of a view button).

The digest 104 operates as “digital fingerprint” that is useful for detecting any modification to the EFT disbursement file 86. More specifically, the hash algorithm is an algorithm specified by the payment processor 14 and is such that it is computationally infeasible to produce any alternate data file that yields the same hash result and even more infeasible to produce an alternate data file that both yields the same hash result and has controllable content such that it could be configured as an EFT disbursement file 86 with specifically controlled disbursement amounts to controlled payees. In the exemplary embodiment, the hash algorithm may be the SHA-1 secure hash algorithm.

If the authorized user 50 elects to view the entire EFT disbursement file 86, a request for the EFT disbursement file 86 is transferred to the payment management system 24 over the first SSL connection 108 as represented by step 211. In response, the payment management system 24 streams the entire EFT disbursement file 86 to the remote system 16 for user review as represented by step 212 in a separate browser window.

When the authorized user 50 elects to approve the EFT disbursement file 86 (e.g. selection of the sign button), the payment management application 34 prepares an authorization response 112 as shown in FIG. 2d. The authorization response 112 comprises a response data structure 123 and verification components 117 which include the summary attributes 105 and the digest 104. The purpose of returning the summary attributes 105 and the digest 104 to the payment management system 24 is to assure that they have not been altered during the processes.

To prepare the authorization response 112, the payment management application 34 builds and passes a dummy data string to the file authentication component 121 as part of a sign and package processing call as represented by step 215. The file authentication component 121 performs the steps previously discussed with respect to a sign and package processing call and returns, at step 216, a dummy authentication data structure 127 as represented by FIG. 2b.

The dummy authentication structure 127 is a data structure expected by the payment processing server 14 which includes information for authenticating a payments file 84 submitted therewith. However, because dummy data was presented with the processing call, the dummy authentication data structure 127 includes a dummy digest 129 (e.g. an SHA-1 hash of the dummy data file), a dummy digital signature 131 (e.g. a digital signature of an SHA-1 hash of a combination of additional authenticated attributes and the dummy digest 129), and the authorized user's digital certificate and certificate chain 96.

The application 34 further, at step 217, calculates the additional message attributes 111 (such as the signing date) and passes the combination of the digest and the additional message attributes 109 (e.g the authenticated attributes) to the file authentication component 121 as part of a digital signature only processing call. The file authentication component 121 performs the steps previously discussed with respect to a digital signature only processing call and returns, at step 218, a digital signature 110 of an SHA-1 hash of the authenticated attributes.

After receiving a response to both the sign and package processing call and the digital signature only processing call, the application 34 prepares the authorization response 112 (as shown in FIG. 2d) for return to the payment management system 24 over the first SSL connection 108 as represented by step 220.

As discussed, the authorization response 112 comprises the authentication data structure 123 and verification components 117. To build the authentication data structure 123 for the authentication response 112, the payment management application 34: i) replaces the dummy digest 129 in the dummy data structure 127 with the digest 104 from the authorization request 102; and ii) replaces the dummy digital signature 131 in the dummy data structure 127 with the digital signature 110 obtained in response to the signature only processing call.

Upon receipt of the authorization response 112, the payment management system 24: i) verifies that the verification components 117 match the summary attributes 105 and the digest 104 provided in the authorization request 102, and ii) builds an EFT submission 84 (as shown in FIG. 2e) for submission to the payment processing server 14, which as discussed, comprises the EFT disbursement file 86 and the authentication data structure 123.

The payment management system 24 then establishes a second SSL connection 114 with the payment processing server 14 as represented by step 222.

To ensure that any EFT submission 84 is authorized by a person who the financial institution has issued a hardware key 20, the payment processing server 14 includes a digital certificate verification system 86 for authenticating the user of any system making an EFT submission to the payment processing server 14 and verifying the integrity of the electronic fund transfer payment records within the EFT disbursement file 86 of the EFT submission 84.

After the second SSL connection 114 has been established, the payment processing server 14 presents an authentication challenge 1 15 to the payment management system 24 in a known manner at step 224. The authentication challenge 115 may include a randomly generated string and is presented as a request for: i) return of the digital certificate and certificate chain 96 of the authorized user 50; and ii) return of a digital signature of the randomly generated string.

By verifying the certificate authority's signature, the payment processing server 14 can be assured that the public encryption key is properly bound to the authorized user 50 and by verifying the authorized user's signature of the randomly generated string, the payment processing server 14 can be assured that it is the authorized user 50 that responded to the authentication challenge 115.

To enable the payment processing server 14 to authenticate the authorized user of the remote system 16, the payment management system 24 includes systems for responding the authentication challenge 115. More specifically, after the payment management system 24 receives the authentication challenge 115 on second SSL connection 114, it presents the authentication challenge 1 15 (as well as the credentials of the second SSL connection 114) to the payment management application 34 on the first SSL connection 108 as represented by step 226. The payment management application 34 running on the remote system 16 in turn presents the authentication challenge 115 to the file authorization component 121 as part of a sign and package processing call as represented by step 228.

The file authorization component 121 performs the steps previously discussed with respect to a sign and package processing call to generate a challenge response 116 which is returned to the payment management application 34 as represented by step 230. The challenge response 116 includes a digital signature of the random string and the digital certificate and certificate chain 96 of the authorized user.

The payment management application 34 returns the challenge response 116 to the payment management system 24 as represented by step 232. And, the payment management system 24 returns the challenge response 116 to the payment processing server 14 as represented by step 234.

After verification of the challenge response 116, the payment processing server 14 will accept an EFT submission 84 from the payment management system 24 and provide an indication that the challenge response 116 has been properly signed by an authorized user 50 as represented by step 235. Step 236 represents the payment management system 24 presenting the EFT submission 84 to the payment processing server 14.

Upon receipt of the EFT submission 84, the payment processing server 14 verifies the integrity of the EFT disbursement file 86 in a known manner. More specifically, the payment processing server 14 verifies that the digital signature 110 is a digital signature performed by the hardware key 20 assigned to the authorized user (that properly authenticated pursuant to steps 224-235) and verifies that the digest 104 matches the EFT disbursement file 86. If all verifications are complete, the payment processing server will generate a submission report and return the submission report to the payment management system 24 in a known manner as represented by step 238.

The payment management application 34 comprises a log on module 33 and an EFT submission module 38. As discussed, these modules are for purposes of illustrating the invention and those skilled in the art will recognize that the functions discussed with respect to these modules may be implemented utilizing other module configurations.

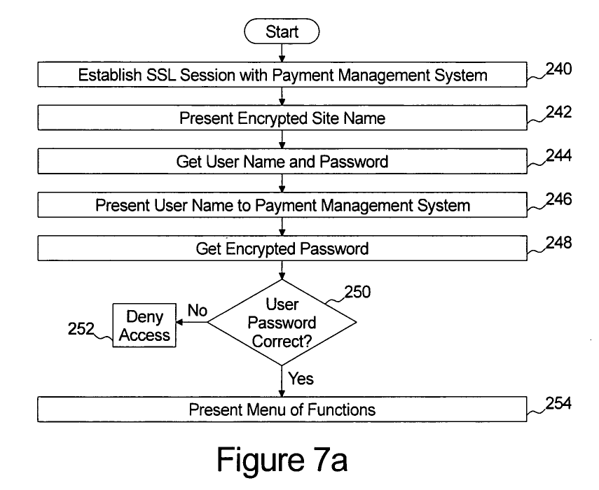

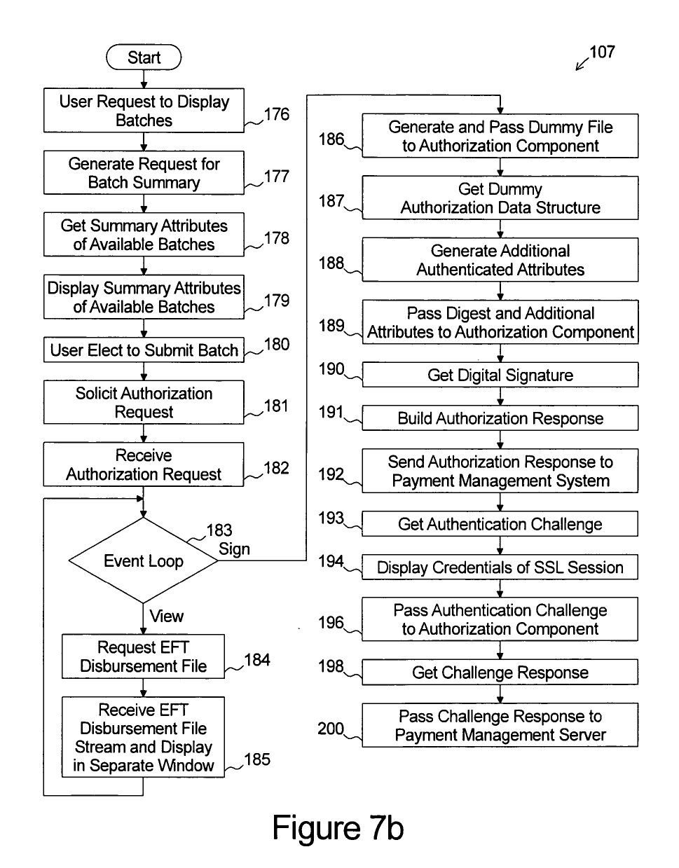

The flow chart of FIG. 7a represents exemplary operation of the log on module 33. Step 240 represents initiating the first SSL connection 108 to the payment management system 24 and step 242 represents providing the encrypted site name to the payment management system 24. Steps 240 and 242 correspond to steps 202 and 203 of FIG. 3 respectively.

Step 244 represents challenging the user to input his or her logon credentials and obtaining user input his or her user name and password. Step 246 represents presenting the user name to the payment management system 24 and step 248 represents obtaining the encrypted password from the payment management system 24. Steps 246 and 248 correspond to steps 204 and 206 of FIG. 3.

Step 250 represents encrypting the password entered by the user and comparing it to the encrypted password 44 provided by the payment management system 24. If they do not match, the user has entered the correct password and access to the application 34 is denied at step 252. Alternatively, if the passwords match, the application 34 presents a menu of functions available to the authorized user 50 at step 254. The menu of functions available to the authorized user may include only those functions which the user is authorized to perform in accordance with the access permissions 52 of the user authentication and access level table 40.

The flow chart of FIG. 7b represents exemplary operation of the EFT submission module 38 of the payment management application 34. Step 176 represents receiving user selection of a menu choice to display batches available for submission as part of an EFT disbursement file 86 and step 177 represents generating a request for available batches to the payment management system 24. Step 178 represents receiving summary attributes of available batches for display in a grid format. Steps 177 and 178 corresponds to steps 208 and 208 of FIG. 3 respectively.

Step 179 represents displaying the summary attributes of available and step 180 represents obtaining user selection of batch(es) for submission. Step 181 represents soliciting an authorization request 102 for the selected EFT disbursement file 86 from the payment management system 24. Step 181 corresponds to step 209 of FIG. 3.

Step 182 represents receiving the authorization request 102 from the payment management system 24. Step 182 corresponds to step 210 of FIG. 3.

After receipt of the authorization request 102, the summary attributes of the EFT disbursement file 86 are displayed along with selection buttons for reviewing the entire EFT disbursement file 86 (e.g. the view button) and approving the EFT disbursement file for submission to the payment processing server 14 (e.g. the sign button). Step 183 represents entering an event loop waiting for user selection to either review the entire EFT disbursement file 86 or to approve the EFT disbursement file 86.

In the event that the user elects to review the EFT disbursement file 86, a request for the EFT disbursement file 86 is generated at step 184 and the payment management system 24 streams the entire EFT disbursement file 86 to the payment management application 34 at step 185. Steps 184 and 185 correspond to steps 211 and 212 of FIG. 3.

In the event that the authorized user 50 elects to approve the disbursement file 86 (e.g. selection of the sign button), a dummy data file is generated and passed to the file authentication component 121 as part of a sign and package processing call at step 186. Step 187 represents receiving the dummy data structure 127 back from the file authentication component 121. Steps 186 and 187 correspond to steps 215 and 216 of FIG. 3.

Step 188 represents generating the additional message attributes 111 such as the signing date and step 189 represents passing the authenticated attributes 109 (e.g. digest 104 and additional message attributes 111) to the file authentication component 121 as part of a sign only processing call and step 190 represents receiving the digital signature 110 back from the file authentication component 121. Steps 189 and 190 correspond to steps 217 and 218 of FIG. 3.

Step 191 represents building the authorization response 112 and step 192 represents sending the authorization response 112 to the payment management system 24 as previously discussed with respect to step 220 of FIG. 3.

Step 193 represents receiving the authentication challenge 115 (and credentials of the second SSL connection 114 established between the payment management system 24 and the payments processing server 14) as previously discussed with respect to step 226 of FIG. 3.

Step 194 represents displaying the credentials of the SSL connection 114 and step 196 represents passing the authentication challenge1 15 to the file authentication component 121 as part of a sign only processing call. Step 198 represents receiving the challenge response 116 back from the file authentication component 121 as previously discussed with respect to steps 228 and 230 of FIG. 3 respectively.

Step 200 represents passing the challenge response 116 to the application 34 over the SSL connection 108 as previously discussed with respect to step 232 of FIG. 3. Step 200 corresponds to step 166 of FIG. 10 which represents the application 34 receiving the challenge response 116 from the remote system 16.

Payment Management System

As previously discussed, the payment management system 24 comprises the network system 32, the user authentication and access level table 40, a payments database 56, and a sort/routing code and account number database 39, and a database application 25.

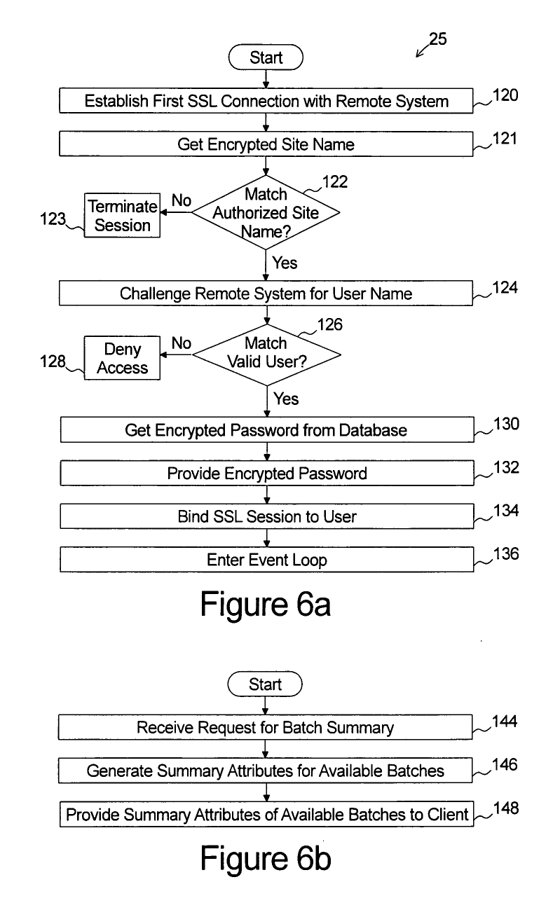

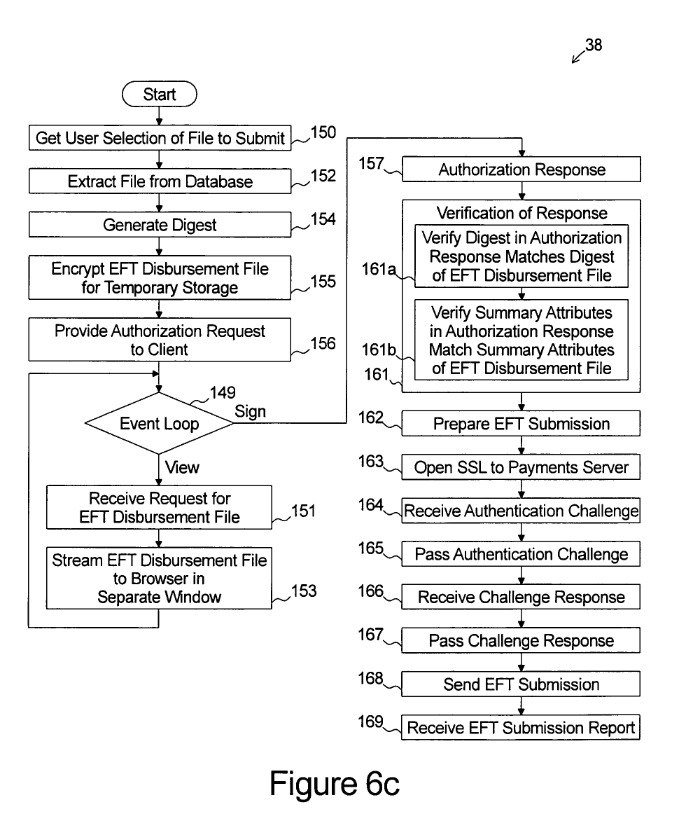

The database application comprises a log on module 35, a batch selection module 30, and an EFT submission module 37. While the database application 25 may include a multitude of functions useful for recording, reporting, and analyzing disbursement data to the payments database 56 in accordance with transactions and queries provided by the payment management application 34 of each remote system 16. For purposes of illustrating the present invention, the database application 25 performs at least need to perform as previously discusses with respect to FIG. 3 and more specifically performs at least the functions of the log on module 35 discussed with respect to FIG. 6a, the batch selection module 30 discussed with respect to the flow chart of FIG. 6b, and the EFT submission module 37 discussed with respect to the flow chart of FIG. 6c.

Turning to FIG. 6a, a flow chart showing exemplary processing steps of the log on module 35 permitting a payment management application 34 to establish a session with the database application 25 is shown.

Step 120 represents the database application 25 (via the network systems 32) interfacing with the payment management application 34 (via the network services 88) of the remote system 16 to establish the first SSL connection 108 with the initiating remote system 16. Step 120 corresponds to step 240 of FIG. 7a and step 202 of the ladder diagram of FIG. 3.

After the first SSL connection 108 is open, step 121 represents receiving the site name of the remote system 16 in encrypted form over the first SSL connection 108. Step 121 corresponds to step 242 of FIG. 7a and step 203 of the ladder diagram of FIG. 3.

Step 122 represents determining whether the encrypted site name matches an authorized site name. If it does not, the session is terminated at step 123. If the encrypted site name matches the name of an authorized site, the database application 25, at step 124, challenges the remote system 16 to provide a user and receiving a user name from the remote system. Step 124 corresponds to step 246 of FIG. 7a and step 204 of the ladder diagram of FIG. 3.

Step 126 represents the comparing the user name 42 tendered by the remote system 16 to logon credentials 51 (FIG. 4) of authorized users 50 to identify the authorized user 50. If the tendered user name 42 does not match logon credentials 51 at step 126, access is denied at step 128. If the tendered user name 42 matches that of an authorized user, the encrypted password 42 is retrieved from the database 40 at step 130 and provided to the payment management application 34 at step 132. Step 132 corresponds to step 248 of FIG. 7a and step 206 of the ladder diagram of FIG. 3.

Step 134 represents binding the SSL connection 108 to the payment management application 34 of the remote system 16 and step 136 represents entering an event loop waiting for instructions from the payment management application 34.

The flow chart of FIG. 6b represents exemplary processing steps of the batch selection module 30 receiving a request to review batches available for submission and providing, in response, summary attributes of available batches to the remote system 16 for user selection.

Step 144 represents receiving a request for batch summary from the payment management application 34 of the remote system and step 146 represents generating or obtaining summary attributes 105 for available batches.

Referring briefly to FIG. 5, the payment database 56 includes a plurality of records 57, each of which represents a disbursement. Each field 57 is identified by a unique index 58. Associated with the unique index 58 are a payment file ID 60, identification of the payee 62, the amount of the payment 64, the status of the payment 66, the entry identification 68 which is the identification of the authorized user 50 entering the payment 68, the approval identification 70 which is identification of the authorized user 50 submitting the payment as part of an electronic fund transfer batch, and a payment date 72.

The database application 25 writes data to and reads data from each of the user authentication and access level table 40 and the payment database 56 in accordance with instructions provided by the payment application 34 of a remote system 16.

The various payments 64 may be selected and formatted to create an EFT disbursement file 86 in the format required by the payment processing server 14. In the exemplary embodiment, formatting the EFT disbursement file 86 may comprise formatting batches of payments 64 as a BACS single batch submission, a BACS multiple batch submission, or a BACS bureau submission.

The database application 25 validates batch fields of the EFT disbursement file 86, performs a duplicate data verification, and performs a date roll. More specifically, the database application 25 validates field length, character range, transaction codes, and data type for fields within the batch. The duplicate data verification may comprise comparing the batches of payments selected for inclusion within the submission with batches included within other submissions. By using comparison rules, if there is similarity above a threshold, the database application 25 can warn that a batch may be a duplicate.

The date role comprises verifying that the payment date 72 of each payment included within the batch matches the business day on which the batch is to be paid by the financial institution controlling the payment processing server 14—and changes the payment date 72 if required.

Sort code (or routing code) validation may comprise comparing the sort code (or routing code) and account number of each record to valid sort codes (or routing codes) and account numbers as represented by a sort/routing code and account number database 39.

Step 272 represents generating pre-submission reports. The pre-submission reports may include a full report which provides payment detail of every disbursement within the batch, a partial report which provides payment detail for only the largest disbursements within the batch, a summary report which provides summary values calculated from the batch such as total quantity of transactions and total transaction value, and an error report which includes field, character, transaction code, and data type errors that may have been discovered when performing batch validation.

Returning to FIG. 6b, these reports may be part of the summary attributes 105 which are presented to the remote system 16 for review by the authorized user 50 at step 148. Step 148 corresponds to step 208 of the flow chart of FIG. 3.

FIG. 6c represents exemplary processing steps of the EFT submission module 37 receiving user selection of a EFT disbursement file 86 for submission to the payment processing server 14 and generating an EFT submission 84.

Step 150 represents obtaining the user selection of the EFT disbursement file 86 for submission. More specifically, step 150 represents the database application 25 receiving the user's selection of the EFT disbursement file 86 that the authorized user 50 desires to submit to the payment processing server 14.

Step 152 represents extracting the selected EFT disbursement file 86 from the payments database 56, step 154 represents generating the digest 104 of the EFT disbursement file 86, and step 155 represents encrypting the EFT disbursement file 86 for temporary storage outside of the encrypted database 56. Steps 153,154, and 155 may be performed in parallel.

Step 156 represents building the authorization request 102 and sending the authorization request 102 to the payment management application 34 of the remote system 16 over the first SSL connection 108 as previously discussed with respect to FIG. 3.

After the authorization request 102 has been sent to the remote system 16, the database application 25 enters an event loop (represented by box 149) wherein it is waiting for the remote system 16 to respond with either a request for the entire EFT disbursement file 86 (if the user selects the button to view the entire EFT disbursement file 86) or with an authorization response 112 (after the remote system performs various steps in response to the user selecting the sign button).

In the event that the remote system 16 responds with a request for the entire EFT disbursement file 86 as represented by step 151, the EFT disbursement file 86 is streamed to the remote system 16 at step 153.

In the event that the remote system 16 responds with an authorization response 112 as represented by step 157, then the application 34 performs a series of steps needed to: i) verify the integrity of the remote authorization; ii) prepare the EFT submission 84 iii) authenticate the user of the remote system 16 to the payment processing server 14; and iv) present the EFT submission 84 to the payment processing server 14.

More specifically, step 161 represents verifying the verification components 117 of the authorization response 112. Specifically step 161 a represents verifying that the digest 104 in the authorization response 112 matches the digest 104 included in the authorization request 102. Step 161 b represents verifying that the summary attributes 105 in the authorization response 112 matches the summary attributes 105 in the authorization request 102.

Step 162 represents preparing the EFT submission 84 by combining the EFT disbursement file 86 with the authentication data structure 123 from the authorization response 112.

Step 163 represents opening the second SSL connection 114 to the payment processing server 14 as previously discussed with respect to step 222 of FIG. 3.

Step 164 represents the application 34 receiving the authentication challenge 115 from the payment processing server 14 over the second SSL connection 114 and step 165 represents the application 34 passing the authentication challenge 115 to the remote system 16 over the first SSL connection 108 as previously discussed with respect to steps 224 and 226 of FIG. 3 respectively.

Step 166 represents the application 34 receiving the challenge response 116 from the remote system 16 over the first SSL connection 108 and step 167 represents the application 34 passing the challenge response 116 to the payment processing server 14 over the second SSL connection 114 as previously discussed with respect to steps 232 and 234 of FIG. 3 respectively.

Assuming that the authentication challenge 116 properly identifies the authorized user 50 of the remote system 16, step 168 represents passing the EFT submission 84 to the payment processing server 14 over the second SSL connection 114 and step 169 represents receiving the submission report 238 back from the payment processing server 14 in a known manner as previously discussed with respect to steps 236 and 238 of FIG. 3 respectively.

The above described systems provide for a secure method of maintaining records or payments on a centralized database and provide for a secure method for an authorized user of a remote system to properly authorize an EFT disbursement file for submission to a payments processing server.

Although the invention has been shown and described with respect to certain preferred embodiments, it is obvious that equivalents and modifications will occur to others skilled in the art upon the reading and understanding of the specification. It is envisioned that after reading and understanding the present invention those skilled in the art may envision other processing states, events, and processing steps to further the objectives of the modular multi-media communication management system of the present invention. The present invention includes all such equivalents and modifications, and is limited only by the scope of the following claims.

1. A system for approving an electronic fund transfer disbursement file and instructing a remote payment management system to generate and electronic fund transfer system to a payment processing server, the system comprising:
a network services module for establishing a secure connection to the remote payment management system;
a digital signature system for:
returning a digital signature of a data file in response to a signature only processing call; and
returning a digital signature data structure in response to receiving a sign and package processing call;
an EFT submission module coupled to the network services module for:
obtaining an authorization request corresponding to the electronic fund transfer disbursement file from the remote payment management system, the authorization request comprising a digest of the electronic fund transfer disbursement file;
passing a dummy data file to the digital signature system as part of a sign and package processing call;
obtaining a dummy data structure from the digital signature system, the dummy data structure comprising a dummy digest, a dummy digital signature of the dummy digest, and a digital certificate;
passing the digest to the digital signature system as part of a sign only processing call;
obtaining a digital signature of the digest from the digital signature system;
building an authentication data structure from the dummy data structure by replacing the dummy digest with the digest and replacing the dummy digital signature with the digital signature of the digest; and
returning the authentication data structure to the payment management system.

2. The system of claim 1, wherein the EFT submission module further provides for:
returning the authentication data structure to the payment management system as part of an authorization response, the authorization response comprising the authentication data structure and verification components, the verification components comprising the digest.

3. The system of claim 2, wherein:
the authorization request further comprises summary attributes, the summary attributes comprising at least one attribute selected from the group of attributes consisting of: i) the total number of disbursements in the electronic fund transfer disbursement file; ii) the highest valued disbursement in the electronic fund transfer disbursement file; and iii) the sum of all disbursements in the electronic fund transfer disbursement file; and
the verification components further comprise the summary attributes.

4. The system of claim 1, wherein the EFT submission module further provides for:
obtaining, from remote payment management system:
i) credentials of a secure connection between the remote payment management system and the payment processing server; and
ii) an authentication challenge, the authentication challenge comprising a data string generated by the payment processing server;
displaying the credentials of the secure connection between the remote payment management system and the payment processor;
passing the data string to the digital signature system as part of a sign and package processing call;
obtaining a challenge response from the digital signature system; and
returning the challenge response to the remote payment management system.

5. The system of claim 4, wherein the EFT submission module further provides for:
returning the authentication data structure to the payment management system as part of an authorization response, the authorization response comprising the authentication data structure and verification components, the verification components comprising the digest.

6. The system of claim 5, wherein:
the authorization request further comprises summary attributes, the summary attributes comprising at least one attribute selected from the group of attributes consisting of: i) the total number of disbursements in the electronic fund transfer disbursement file; ii) the highest valued disbursement in the electronic fund transfer disbursement file; and iii) the sum of all disbursements in the electronic fund transfer disbursement file; and
the verification components further comprise the summary attributes.

7. A system for approving an electronic fund transfer disbursement file and instructing a remote payment management system to generate and electronic fund transfer system to a payment processing server, the system comprising:
a network services module for establishing a secure connection to the remote payment management system;
a digital signature system for:
returning a digital signature of a data file in response to a signature only processing call; and
returning a digital signature data structure in response to receiving a sign and package processing call;
a log on module coupled to the network services module for:
initiating the secure connection to the remote payment management system;
soliciting user entry of user credentials and obtaining a user name and user password in response thereto;
providing the user name to the remote payment management system;
receiving an encrypted password from the remote payment management system, the encrypted password being an encrypted representation of a password corresponding to the user name;
comparing the encrypted password to an encrypted representation of the password provided by the user to determine that user is authentic if the two match; and
an EFT submission module coupled to the network services module which operates only if the user is authentic and provides for:
obtaining an authorization request corresponding to the electronic fund transfer disbursement file from the remote payment management system, the authorization request comprising a digest of the electronic fund transfer disbursement file;
passing a dummy data file to the digital signature system as part of a sign and package processing call;
obtaining a dummy data structure from the digital signature system, the dummy data structure comprising a dummy digest, a dummy digital signature of the dummy digest, and a digital certificate;
passing the digest to the digital signature system as part of a sign only processing call;
obtaining a digital signature of the digest from the digital signature system;
building an authentication data structure from the dummy data structure by replacing the dummy digest with the digest and replacing the dummy digital signature with the digital signature of the digest; and
returning the authentication data structure to the payment management system.

8. The system of claim 7, wherein the EFT submission module further provides for:
returning the authentication data structure to the payment management system as part of an authorization response, the authorization response comprising the authentication data structure and verification components, the verification components comprising the digest.

9. The system of claim 8, wherein:
the authorization request further comprises summary attributes, the summary attributes comprising at least one attribute selected from the group of attributes consisting of: i) the total number of disbursements in the electronic fund transfer disbursement file; ii) the highest valued disbursement in the electronic fund transfer disbursement file; and iii) the sum of all disbursements in the electronic fund transfer disbursement file; and
the verification components further comprise the summary attributes.

10. The system of claim 7, wherein the EFT submission module further provides for:
obtaining, from remote payment management system:
i) credentials of a secure connection between the remote payment management system and the payment processing server; and
ii) an authentication challenge, the authentication challenge comprising a data string generated by the payment processing server;
displaying the credentials of the secure connection between the remote payment management system and the payment processor;
passing the data string to the digital signature system as part of a sign and package processing call;
obtaining a challenge response from the digital signature system; and
returning the challenge response to the remote payment management system.

11. The system of claim 10, wherein the EFT submission module further provides for:
returning the authentication data structure to the payment management system as part of an authorization response, the authorization response comprising the authentication data structure and verification components, the verification components comprising the digest.

12. The system of claim 11, wherein:
the authorization request further comprises summary attributes, the summary attributes comprising at least one attribute selected from the group of attributes consisting of: i) the total number of disbursements in the electronic fund transfer disbursement file; ii) the highest valued disbursement in the electronic fund transfer disbursement file; and iii) the sum of all disbursements in the electronic fund transfer disbursement file; and
the verification components further comprise the summary attributes.

13. A method of approving an electronic fund transfer disbursement file and instructing a remote payment management system to generate and electronic fund transfer system to a payment processing server, the method comprising:
initiating a secure connection to the remote payment management system;
soliciting user entry of user credentials and obtaining a user name and user password in response thereto;
providing the user name to the remote payment management system;
receiving an encrypted password from the remote payment management system, the encrypted password being an encrypted representation of a password corresponding to the user name;
comparing the encrypted password to an encrypted representation of the password provided by the user to determine that user is authentic if the two match; and
obtaining an authorization request corresponding to the electronic fund transfer disbursement file from the remote payment management system only if the user is authentic, the authorization request comprising a digest of the electronic fund transfer disbursement file;
passing a dummy data file to a digital signature system and obtaining a dummy data structure in response thereto, the dummy data structure comprising a dummy digest, a dummy digital signature of the dummy digest, and a digital certificate;
passing the digest to the digital signature system and obtaining a digital signature of the digest in response thereto;
building an authentication data structure from the dummy data structure by replacing the dummy digest with the digest and replacing the dummy digital signature with the digital signature of the digest; and
returning the authentication data structure to the payment management system.

14. The method of claim 13, wherein the step of returning the authentication data structure to the payment management system comprises returning the authentication data structure to the payment management system as part of an authorization response, the authorization response comprising the authentication data structure and verification components, the verification components comprising the digest.

15. The method of claim 14, wherein:
the authorization request further comprises summary attributes, the summary attributes comprising at least one attribute selected from the group of attributes consisting of: i) the total number of disbursements in the electronic fund transfer disbursement file; ii) the highest valued disbursement in the electronic fund transfer disbursement file; and iii) the sum of all disbursements in the electronic fund transfer disbursement file; and
the verification components further comprise the summary attributes.

16. The method of claim 13, further comprising:
obtaining, from remote payment management system:
i) credentials of a secure connection between the remote payment management system and the payment processing server; and
ii) an authentication challenge, the authentication challenge comprising a data string generated by the payment processing server;
displaying the credentials of the secure connection between the remote payment management system and the payment processor;
passing the data string to the digital signature system as part of a sign and package processing call;
obtaining a challenge response from the digital signature system; and
returning the challenge response to the remote payment management system.

17. The method of claim 16, wherein the step of returning the authentication data structure to the payment management system comprises returning the authentication data structure to the payment management system as part of an authorization response, the authorization response comprising the authentication data structure and verification components, the verification components comprising the digest.

18. The method of claim 17, wherein:
the authorization request further comprises summary attributes, the summary attributes comprising at least one attribute selected from the group of attributes consisting of: i) the total number of disbursements in the electronic fund transfer disbursement file; ii) the highest valued disbursement in the electronic fund transfer disbursement file; and iii) the sum of all disbursements in the electronic fund transfer disbursement file; and
the verification components further comprise the summary attributes.
